(19) United States
(12) Patent Application Publication
(10) Pub. No.: US 2010/0134418 A1
(43) Pub. Date: Jun. 3, 2010

(54) OPPOSITE FACING DEVICE KEYPAD

(75) Inventor: Tobias A. Muresianu, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/326,265

(22) Filed: Dec. 2, 2008

(51) Int. Cl. G06F 3/02

(52) U.S. Cl. 345/169

(57) ABSTRACT

An opposite facing device keypad is described. In embodiment(s), a portable device includes an integrated display positioned on a first surface of the portable device to display typed inputs. The portable device can also include touch-type keys for typing to initiate the typed inputs. The touch-type keys can be disposed relative a second surface of the portable device, and the second surface faces substantially opposite the first surface to position the touch-type keys for typing when the portable device is held to view the integrated display.

### BACKGROUND

Portable devices, such as an ultra-mobile personal computer (UMPC), mobile phone, personal digital assistant (PDA), and the like are becoming increasingly popular and ubiquitous. Traditional portable device keypads, however, fail to provide an ergonomic and/or practical touch-typing solution for a user when holding such a device. This can be due to the placement and/or the small size of the thumb-typing input keys on these devices.

### SUMMARY

This summary is provided to introduce simplified concepts of an opposite facing device keypad. The simplified concepts are further described below in the Detailed Description. This summary is not intended to identify essential features of the claimed subject matter, nor is it intended for use in determining the scope of the claimed subject matter.

In embodiment(s) of an opposite facing device keypad, a portable device includes an integrated display positioned on a first surface of the portable device to display typed inputs. The portable device can also include touch-type keys for typing to initiate the typed inputs. The touch-type keys can be disposed relative a second surface of the portable device, and the second surface faces substantially opposite the first surface to position the touch-type keys for typing when the portable device is held to view the integrated display.

In other embodiment(s), a portable device can include a space input touch-type key for typing a space. The space input touch-type key can be disposed relative the first surface to position the space input touch-type key for typing a space when the portable device is held. Alternatively or in addition, a portable device can include an input control configured to lock/unlock the touch-type keys that are disposed relative the second surface of the portable device. The input control can be disposed relative the first surface to position the input control for selection when the portable device is held. Alternatively or in addition, a portable device can include a programmable touch-type key for a programmed input. The programmable touch-type key can be disposed relative the first surface to position the programmable touch-type key for selection when the portable device is held.

In other embodiment(s), a portable device can include touch-type keys that are removeably attached to the second surface of the portable device. For example, a portable device can include the touch-type keys as part of a protective case for the portable device. The touch-type keys can be positioned proximate the second surface of the portable device when the portable device is housed in the protective case.

### BRIEF DESCRIPTION OF THE DRAWINGS

Embodiments of an opposite facing device keypad are described with reference to the following drawings. The same numbers are used throughout the drawings to reference like features and components:

FIG. 1 illustrates an example device in which embodiments of an opposite facing device keypad can be implemented.

FIG. 2 illustrates an example system in which embodiments of an opposite facing device keypad can be implemented.

FIG. 3 illustrates example method(s) for an opposite facing device keypad in accordance with one or more embodiments.

FIG. 4 illustrates various components of an example device that can implement embodiments of an opposite facing device keypad.

### DETAILED DESCRIPTION

Embodiments of an opposite facing device keypad provide that a user can touch-type on keypad keys while holding a portable device to view a display that is integrated with the device. The device keypad can be positioned, or disposed relative to a back surface of the device that faces opposite, or away from, a front surface of the device that includes the integrated display. A user can then hold the device to view the display on the front surface of the device while typing on the touch-type keys on the keypad that is facing substantially opposite on the back of the device. The user is able to view the typed inputs on the display while holding the device and typing on the keypad. A portable device can also include thumb input controls positioned on the front surface of the device, such as a space input touch-type key, a keypad lock/unlock control and/or other programmable input controls that can be typed or initiated while a user is holding the device.

While features and concepts of the described devices, systems, and methods for an opposite facing device keypad can be implemented in any number of different environments, systems, and/or various configurations, embodiments of an opposite facing device keypad are described in the context of the following example devices, systems, and environments.

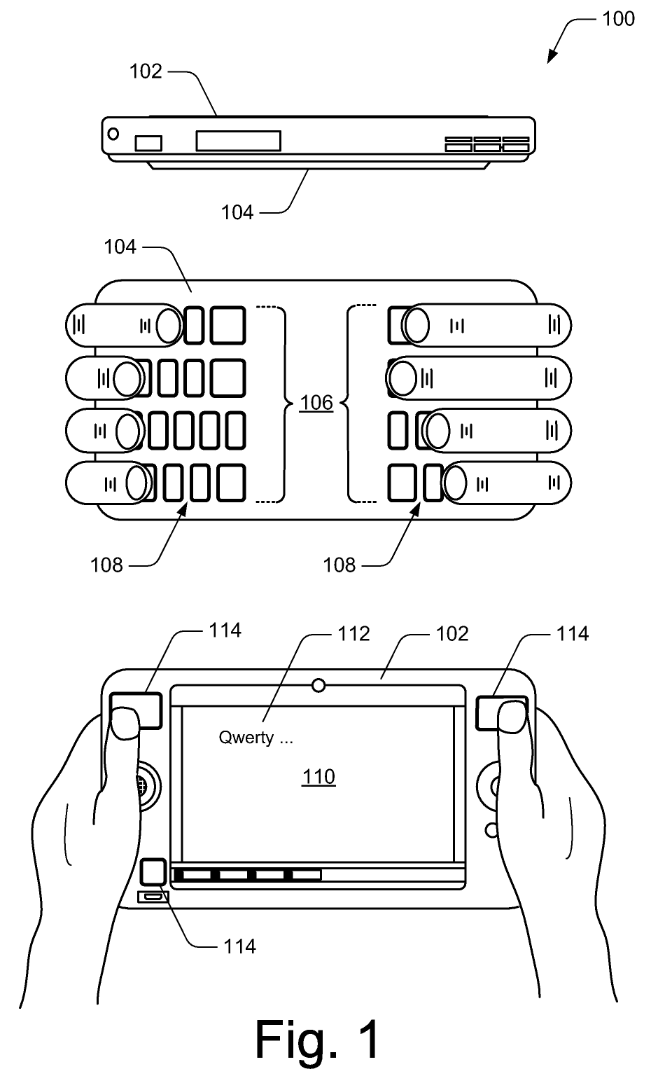

FIG. 1 illustrates an example portable device 100 (shown in three views) in which various embodiments of an opposite facing device keypad can be implemented. In this example, portable device 100 (e.g., a wired and/or wireless device) is illustrated as a portable computer device, such as a UMPC. In other embodiment(s), portable device 100 can be implemented as any one or combination of various portable devices.

Portable device 100 includes a display surface 102 and a keypad surface 104 that faces substantially opposite the display surface 102. A keypad device 106 that includes touch-type keys 108 can be disposed relative the keypad surface 104 of the portable device 100 to position the touch-type keys 108 for typing when the portable device 100 is held to view an integrated display 110. The display surface 102 of the portable device 100 can include the integrated display 110 that displays typed inputs 112 when typed on the touch-type keys 108 of the keypad device 106.

The keypad device 106 can include the touch-type keys 108 arranged in various configurations, and sized to accommodate a user typing similar to using a full-size keyboard. In an embodiment, the touch-type keys 108 can be arranged similar to a split-QWERTY keyboard, but facing away from a user and with the touch-type keys rotated as a group to maintain the relational configuration of the respective touch-type keys. The touch-type keys 108 can also be grouped or otherwise disposed to ergonomically accommodate typing and, in an embodiment, can include tactile indicia (e.g., bumps, brail markings, and/or other touch-identifiers) indicative of touch-type key identity. A user can utilized the tactile indicia to locate the touch-type keys without having to look at the keypad, such as when a user is holding the portable device 100 to view the integrated display 110.

Alternatively or in addition, one or more of the touch-type keys 108 can be tilted relative to the keypad surface 104 to further facilitate ease of typing. In an embodiment, the touch-type keys 108 of the keypad device 106 can be recessed into the keypad surface 104 or housing of the portable device 100 to prevent a touch-type key from being unintentionally depressed or initiated when the keypad surface 104 of the portable device 100 is placed down on another surface. In various embodiments, the touch-type keys 108 can include any number of touch-type keys, such as a full set of alphanumeric keys for a keypad or keyboard, or a partial set of alphanumeric, alphabetic, numeric, and/or any other type of character touch-type keys. Additionally, an individual touch-type key can be associated with any number of functions and/or characters (e.g., an individual touch-type key associated with multiple alphanumeric, alphabetic, numeric, and/or extra characters).

The keypad device 106 can be attached to the keypad surface 104 in any suitable way. For example, keypad device 106 can be integrated into the keypad surface 104. Alternatively or in addition, keypad device 106 can be removeably attached to the keypad surface 104 such that the keypad can be detached from the portable device 100. For example, the touch-type keys 108 can be part of a protective and/or decorative case for portable device 100 such that the touch-type keys are positioned proximate the keypad surface 104 when the device is housed in the protective and/or decorative case.

Various selectable input controls 114, such as one or more touch-type keys, switches, toggle mechanisms, radio dials, and the like can be positioned, located, or otherwise disposed relative the display surface 102 for user-selectable input. The selectable input controls 114 can be implemented as thumb input controls positioned on the display surface 102 of the portable device 100 that can be typed or initiated while a user is holding the device to view the integrated display 110. For example, a user can hold the portable device 100 and initiate selection of an input control 114 with a thumb input while also touch-typing on the keypad device 106 that is relative in position to the back surface (e.g., keypad surface 104) of the portable device and facing substantially opposite the integrated display 110 on the front surface (e.g., display surface 102).

In embodiment(s), an input control 114 can be implemented as a space input touch-type key for typing a space. An input control 114 can also be implemented as a lock/unlock control that can be toggled to lock and/or unlock portable device 100, other selectable input controls 114, and/or the touch-type keys 108, such as when the portable device 100 is placed down on another surface to prevent the touch-type keys 108 from being unintentionally depressed or initiated. An input control 114 can also be implemented as a programmable touch-type key that can be programmed for a control input to initiate a desired function, such as a hot key to initiate a programmable option for one or more of the touch-type keys 108. The selectable input controls 114 can also include a shift, alt, control, and/or any other type of input control implemented as a touch-type key. Although the input controls 114 are shown disposed on or proximate only the display surface 102 in this example, various selectable input controls can be located or positioned for user selection on other surfaces or within the housing of the portable device 100.

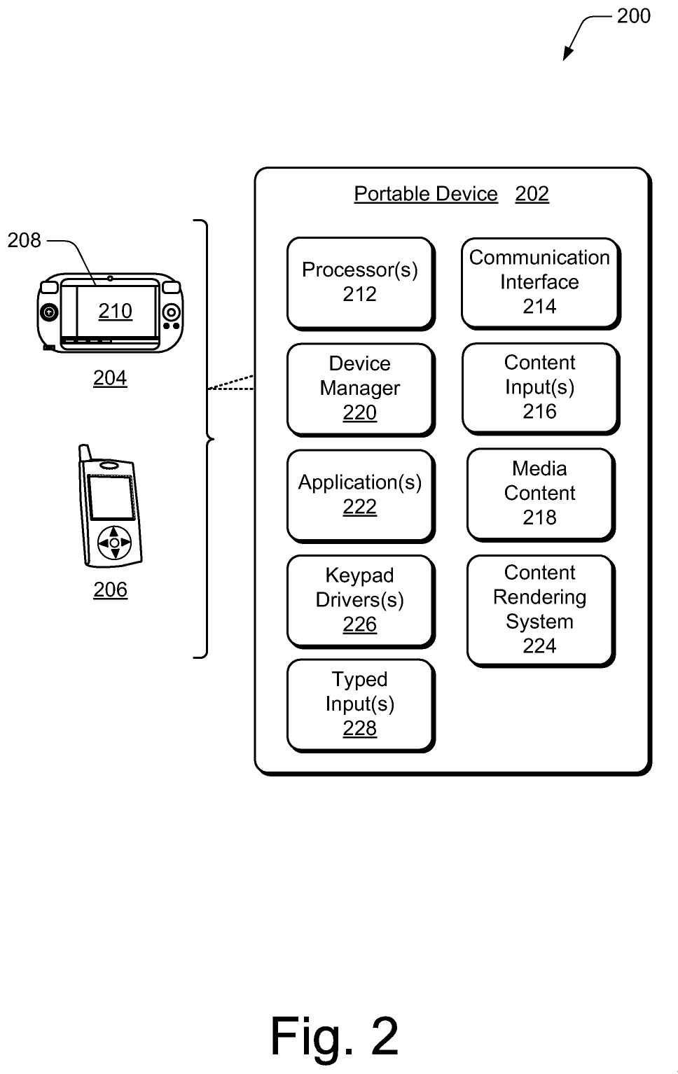

FIG. 2 illustrates an example system 200 in which various embodiments of an opposite facing device keypad can be implemented. Example system 200 includes a portable device 202 (e.g., a wired and/or wireless device) which can be any one or combination of suitable device types including a UMPC 204, a mobile phone 206 (e.g., cellular, VoIP, WiFi, etc.) that is implemented for data, messaging, and/or voice communications, a PDA, a media device (e.g., a personal media player, portable media player, etc.), a gaming device, an appliance device, an electronic device, and the like.

Each of the various portable devices can include an integrated, non-integrated, and/or removeably attached display as well as selectable input controls via which a user can input data. For example, UMPC 204 includes an integrated display 208 on which a user interface 210 can be displayed that can include user interface elements, such as those depicting inputs and/or touch-type inputs initiated by a user. As described with reference to portable device 100 shown in FIG. 1, UMPC 204 can include an opposite facing device keypad (not visible in FIG. 2) facing substantially opposite the surface on which integrated display 208 is positioned. Similarly, mobile phone 206 can include a keypad device of touch-type keys (not visible in FIG. 2) facing substantially opposite the surface on which an integrated display is positioned. To accommodate a keypad that includes input keys of a size suitable for touch-typing, a portable device with limited surface area (e.g., mobile phone 206) can include a slide, flip-out, and/or removable panel that provides a substantially opposite facing surface to accommodate the keypad.

Any of the various portable devices described herein can be implemented with processors, communication components, media content inputs, memory components, storage media, signal processing and control circuits, and a content rendering system. Any of the portable devices can also be implemented for communication via communication network(s) that can include any type of a data network, voice network, broadcast network, an IP-based network, and/or a wireless network that facilitates data, messaging, and/or voice communications. A portable device may be associated with a user (i.e., a person) and/or an entity that operates the device such that a portable device describes logical devices that include users, software, and/or a combination of devices.

In this example, portable device 202 includes one or more processors 212 (e.g., any of microprocessors, controllers, and the like), a communication interface 214 for data, messaging, and/or voice communications, and content input(s) 216 to receive media content 218. Media content can include any type of audio, video, and/or image media content received from any media content source, such as music, video clips, data feeds, interactive games, network-based applications, and any other content. Portable device 202 also includes a device manager 220 (e.g., a control application, software application, signal processing and control module, code that is native to a particular device, a hardware abstraction layer for a particular device, etc.).

Portable device 202 also includes various applications 222 that can be processed, or otherwise executed, by processor(s) 212, such as a word processing application, a music and/or video player, a Web browser, an email application, and the like. Portable device 202 further includes a content rendering system 224 that can render user interfaces from applications 222 to generate a display on any of the portable devices. Portable device 202 also includes keypad drivers 226 that can be implemented as computer-executable instructions and executed by processor(s) 212 to implement various embodiments and/or features of an opposite facing device keypad. In embodiment(s) the keypad drivers 226 can be implemented as components or modules of device manager 220 to facilitate portable device 202 receiving and processing typed inputs 228 from touch-type keys of a keypad device that is integrated with or otherwise disposed relative portable device 202.

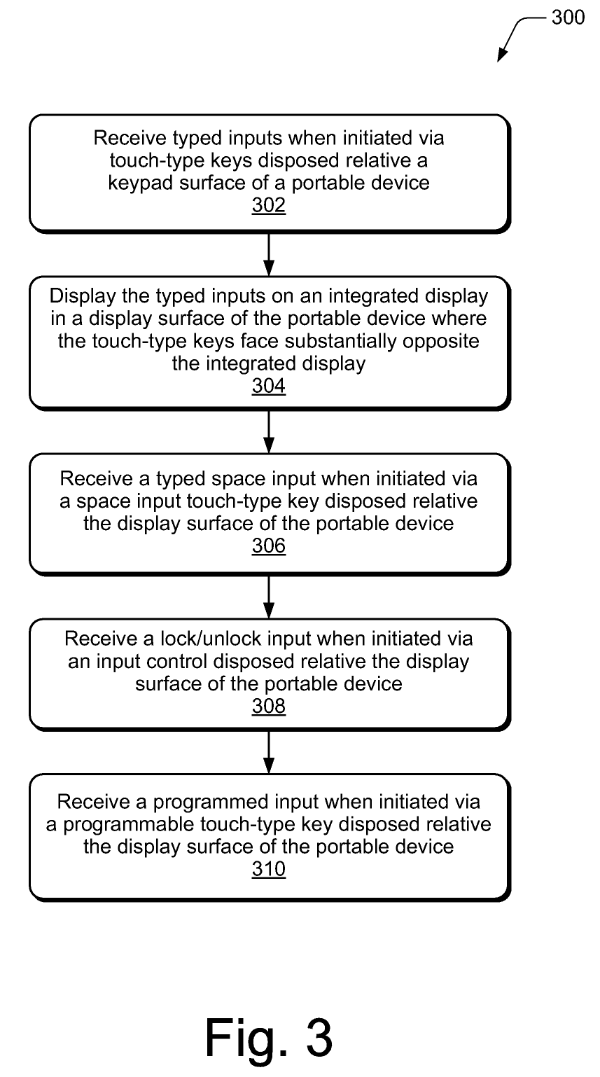

Example method 300 is described with reference to FIG. 3 in accordance with one or more embodiments of an opposite facing device keypad. Generally, any of the functions, methods, procedures, components, and modules described herein can be implemented using hardware, software, firmware, fixed logic circuitry, manual processing, or any combination thereof. A software implementation of a function, method, procedure, component, or module represents program code that performs specified tasks when executed on a computing-based processor. The example method(s) may also be described in the general context of computer-executable instructions, which can include software, applications, routines, programs, objects, components, data structures, procedures, modules, functions, and the like. Further, the features described herein are platform-independent such that the techniques may be implemented on a variety of computing platforms having a variety of processors.

FIG. 3 illustrates example method(s) 300 of an opposite facing device keypad. The order in which the method is described is not intended to be construed as a limitation, and any number of the described method blocks can be combined in any order to implement the method, or an alternate method.

At block 302, typed inputs are received when initiated via touch-type keys disposed relative a keypad surface of a portable device. For example, portable device 101 (FIG. 1) includes a keypad device 106 with touch-type keys 108 that are disposed relative the keypad surface 104 of the portable device 100 to position the touch-type keys 108 for typing when the portable device 100 is held to view an integrated display 110. A user can then hold the device to view the display on the display surface 102 of the device while typing on the touch-type keys 108 on the keypad device 106 to initiate the typed inputs.

At block 304, the typed inputs are displayed on an integrated display in a display surface of the portable device where the touch-type keys face substantially opposite the integrated display. For example, the display surface 102 of portable device 100 includes integrated display 110 that displays typed inputs 112 when typed on the touch-type keys 108 of the keypad device 106. The touch-type keys 108 of the keypad device 106 face substantially opposite the display surface 102 that includes the integrated display 110. Typed inputs initiated by a user on the touch-type keys of keypad device106, and received by portable device 100, are displayed on integrated display 110 while the user holds the portable device to view the integrated display.

At block 306, a typed space input is received when initiated via a space input touch-type key disposed relative the display surface of the portable device. For example, portable device 100 includes various selectable input controls 114, such as a space input touch-type key disposed relative the display surface 102 to position the space input touch-type key for typing a space input when the portable device is held. The space input touch-type key can be implemented as a thumb input control positioned on the display surface 102 of portable device 100 that can be typed or initiated while a user is holding the device to view the integrated display 110. A user can hold portable device 100 and initiate typing a space with a thumb input while also touch-typing on the keypad device 106 that is relative the back surface (e.g., keypad surface 104) of the portable device and facing substantially opposite the integrated display 110 on the front surface (e.g., display surface 102).

At block 308, a lock/unlock input is received when initiated via an input control disposed relative the display surface of the portable device. For example, portable device 100 includes a selectable input control implemented as a lock/unlock control to lock and/or unlock portable device 100, other selectable input controls, and/or the touch-type keys 108. The lock/unlock control can be disposed relative the display surface 102 of portable device 100 to position the selectable input control as a thumb input control when the portable device is held to view the integrated display 110.

At block 310, a programmed input is received when initiated via a programmable touch-type key disposed relative the display surface of the portable device. For example, portable device 100 includes a programmable touch-type key that is programmed for a control input to initiate a desired function. The programmable control can be disposed relative the display surface 102 of portable device 100 to position the programmable touch-type key as a thumb input control when the portable device is held to view the integrated display 110.

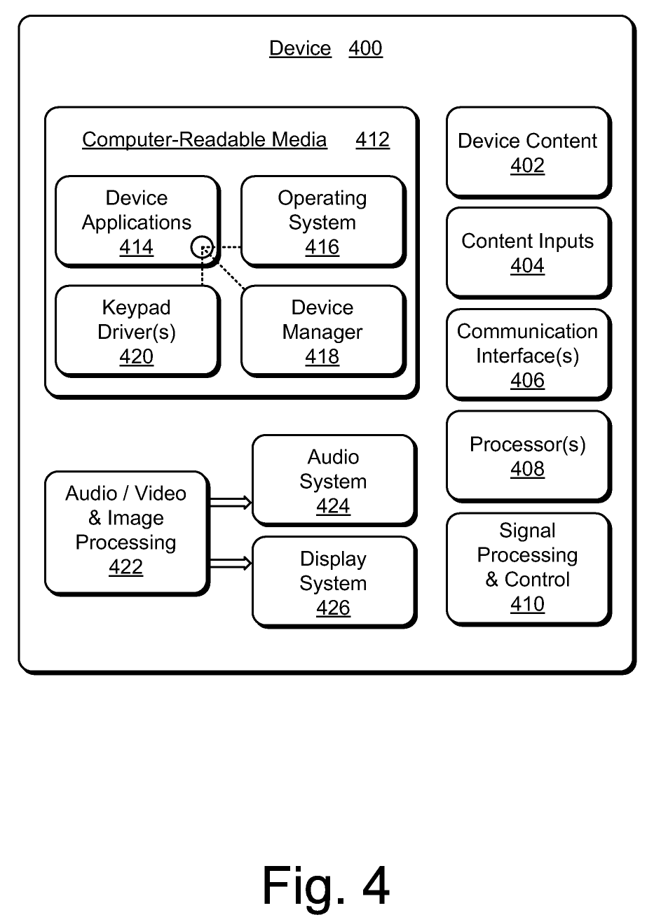

FIG. 4 illustrates various components of an example device 400 that can be implemented as any form of a portable, computing, electronic, appliance, and/or media device to implement various embodiments of an opposite facing device keypad. For example, device 400 can be implemented as any of the various portable devices described with reference to FIG. 1 and/or FIG. 2.

Device 400 can include device content 402, such as configuration settings of the device, media content stored on the device, and/or information associated with a user of the device. Media content stored on device 400 can include any type of data as well as audio, video, and/or image media content. Device 400 can include one or more content inputs 404 via which content can be received. In embodiment(s), the content inputs 404 can include typed inputs initiated by a user via touch-type keys of a keypad disposed relative a keypad surface of device 400. Additionally, the content inputs 404 can include touch-type inputs initiated by a user via one or more selectable input controls positioned relative a display surface of device 400.

Device 400 further includes one or more communication interfaces 406 that can be implemented as any one or more of a serial and/or parallel interface, a wireless interface, any type of network interface, a modem, and as any other type of communication interface. The communication interfaces 406 provide a connection and/or communication link between device 400 and a communication network by which other electronic, computing, and/or communication devices can communicate with device 400.

Device 400 can include one or more processors 408 (e.g., any of microprocessors, controllers, and the like) which process various computer-executable instructions to control the operation of device 400 and to implement embodiments of an opposite facing device keypad. Alternatively or in addition, device 400 can be implemented with any one or combination of hardware, firmware, or fixed logic circuitry that is implemented in connection with signal processing and control circuits which are generally identified at 410.

Device 400 can also include computer-readable media 412, such as one or more memory components, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), any type of a digital versatile disc (DVD), and the like.

Computer-readable media 412 provides data storage mechanisms to store the device content 402, as well as various device applications 414 and any other types of information and/or data related to operational aspects of device 400. For example, an operating system 416 can be maintained as a computer application with computer-readable media 412 and executed on processors 408. Device applications 414 can also include a device manager418 and one or more keypad drivers 420. In this example, device applications 414 are shown as software modules and/or computer applications that can implement various embodiments of an opposite facing device keypad.

Device 400 also includes an audio, video, and/or image processing system 422 that provides audio data to an audio system 424 and/or provides video or image data to a display system 426. The audio system 424 and/or the display system 426 can include any devices or components that process, display, and/or otherwise render audio, video, and image data. The audio system 424 and/or the display system 426 can be implemented as integrated components of the example device 400. Alternatively, audio system424 and/or the display system 426 can be implemented as external components to device 400. Video signals and audio signals can be communicated from device 400 to an audio device and/or to a display device via an RF (radio frequency) link, S-video link, composite video link, component video link, DVI (digital video interface), analog audio connection, or other similar communication link.

Although not shown, device 400 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Although embodiments of an opposite facing device keypad have been described in language specific to features and/or methods, it is to be understood that the subject of the appended claims is not necessarily limited to the specific features or methods described. Rather, the specific features and methods are disclosed as example implementations of an opposite facing device keypad.

1. A portable device, comprising:
an integrated display positioned on a first surface of the portable device and configured to display typed inputs; and
touch-type keys configured for typing to initiate the typed inputs, the touch-type keys disposed relative a second surface of the portable device, and the second surface facing substantially opposite the first surface to position the touch-type keys for typing when the portable device is held to view the integrated display.

2. A portable device as recited in claim 1, further comprising a space input touch-type key configured for typing a space, the space input touch-type key disposed relative the first surface to position the space input touch-type key for typing the space when the portable device is held.

3. A portable device as recited in claim 1, further comprising an input control configured to lock/unlock the touch-type keys disposed relative the second surface of the portable device, the input control disposed relative the first surface to position the input control for selection when the portable device is held.

4. A portable device as recited in claim 1, further comprising a programmable touch-type key configured for a programmed input, the programmable touch-type key disposed relative the first surface to position the programmable touch-type key for selection when the portable device is held.

5. A portable device as recited in claim 1, wherein the touch-type keys disposed relative the second surface of the portable device are removeably attached to the second surface.

6. A portable device as recited in claim 1, wherein the portable device comprises an ultra-mobile personal computer (UMPC).

7. A portable device as recited in claim 1, wherein one or more of the touch-type keys disposed relative the second surface are configured with tactile indicia indicative of their identity.

8. A portable device as recited in claim 1, wherein the touch-type keys are part of a protective case for the portable device, the touch-type keys proximate the second surface of the portable device when the portable device is housed in the protective case.

9. A method, comprising:
displaying typed inputs on a display positioned on a first surface of a portable device; and
receiving one or more of the typed inputs initiated via touch-type keys disposed relative a second surface of the portable device, the second surface facing substantially opposite the first surface to position the touch-type keys for typing when the portable device is held to view the display.

10. A method as recited in claim 9, further comprising receiving a typed space input initiated via a space input touch-type key disposed relative the first surface to position the space input touch-type key for typing the space input when the portable device is held.

11. A method as recited in claim 9, further comprising receiving a lock/unlock input initiated via an input control disposed relative the first surface to position the input control for selection when the portable device is held.

12. A method as recited in claim 9, wherein the touch-type keys disposed relative the second surface of the portable device are removeably attached to the second surface.

13. A method as recited in claim 9, further comprising receiving a programmed input initiated via a programmable touch-type key disposed relative the first surface to position the programmable touch-type key for selection when the portable device is held.

14. A method as recited in claim 9, wherein one or more of the touch-type keys disposed relative the second surface are configured with tactile indicia indicative of their identity.

15. A system, comprising:
a keypad device comprising touch-type keys;
a portable device configured to receive typed inputs initiated via the touch-type keys on the keypad device, the portable device comprising:
a display surface that includes an integrated display configured to display the typed inputs; and
a keypad surface facing substantially opposite the display surface, the keypad surface configured to include the keypad device positioned for typing when the portable device is held to view the integrated display.

16. A system as recited in claim 15, further comprising a space input touch-type key configured to input a typed space, the space input touch-type key proximate the display surface of the portable device and positioned for selection when the portable device is held.

17. A system as recited in claim 15, further comprising an input control configured to lock/unlock the touch-type keys on the keypad device.

18. A system as recited in claim 15, wherein the portable device comprises an ultra-mobile personal computer (UMPC) that includes the keypad device.

19. A system as recited in claim 15, wherein the touch-type keys are arranged in a QWERTY configuration on the keypad device.

20. A system as recited in claim 15, wherein the keypad device is part of a protective case for the portable device, the keypad device proximate the keypad surface of the portable device when the portable device is housed in the protective case.
